(19) United States
(12) Patent Application Publication
(10) Pub. No.: US 2018/0217860 A1
(43) Pub. Date: Aug. 2, 2018

(54) INTEGRATED NETWORK DATA COLLECTION APPARATUS AND METHOD

(71) Applicant: ELECTRONICS AND TELECOMMUNICATIONS RESEARCH INSTITUTE, Daejeon (KR)

(72) Inventors: Jung-Tae KIM, Daejeon (KR); Ik-Kyun KIM, Daejeon (KR)

(73) Assignee: ELECTRONICS AND TELECOMMUNICATIONS RESEARCH INSTITUTE, Daejeon (KR)

(21) Appl. No.: 15/861,792

(22) Filed: Jan. 4, 2018

(30) Foreign Application Priority Data
Feb. 1, 2017 (KR) 10-2017-0014483

(51) Int. Cl. G06F 9/455; H04L 29/08

(52) U.S. Cl. CPC G06F 9/45558; G06F 2009/45595; G06F 2009/45591; H04L 67/1029

(57) ABSTRACT

Disclosed herein are an integrated network data collection apparatus and method. The integrated network data collection apparatus includes a packet collection unit for collecting packets corresponding to one or more virtual machines included in a cloud server, a flow-processing unit for generating flow information based on the collected packets, a session-processing unit for generating session information based on the generated flow information, and a storage unit for storing network data including at least one of the generated flow information and the generated session information.

### CROSS REFERENCE TO RELATED APPLICATION

This application claims the benefit of Korean Patent Application No. 10-2017-0014483, filed Feb. 1, 2017, which is hereby incorporated by reference in its entirety into this application.

### BACKGROUND OF THE INVENTION

### 1. Technical Field

The present invention relates generally to integrated network data collection technology and, more particularly, to technology for collecting network data in an integrated manner based on traffic that occurs when virtual machines are running to perform communication in a cloud server environment.

### 2. Description of the Related Art

In a cloud server environment, one or more virtual machines (VMs) included in a single server provide respective operating systems and services. Respective virtual machines are allocated private Internet Protocol (IP) addresses and perform internal/external communication. From the standpoint of switches that manage communication between servers, all virtual machines perform Virtual Local Area Network (VLAN) communication. Therefore, due to processing overhead, it is difficult to detect pieces of flow information and session information for respective virtual machines.

802.1Q VLAN trunking for establishing a VLAN in a virtual switch is technology that uses a tagging method, and is configured such that a 4-byte tag (composed of a Tag Protocol Identifier [TPID] field: 16 bits, a priority field: 3 bits, a Canonical Format Identifier [CFI] field: 1 bit, and a VLAN ID [VID] field: 12 bits) is added to the header of an Ethernet frame (1518 bytes), and thus target hosts are found for respective VLAN IDs (VIDs) to perform communication. Therefore, since communication to IP addresses allocated to respective virtual machines is not supported, it is difficult to detect related flow information and session information.

Therefore, there is required the development of technology that allows a cloud server itself to process traffic information that is transmitted and received to and from a physical LAN card in a single system, to generate related flow information and session information, and thus to search pieces of session information and flow information for respective virtual machines.

### PRIOR ART DOCUMENTS

### Patent Documents

(Patent Document 1) Korean Patent Application Publication No. 10-2014-0045214 (Date of publication: Apr. 16, 2014, entitled “Integrated VPN Management and Control Apparatus and Method”)

### SUMMARY OF THE INVENTION

Accordingly, the present invention has been made keeping in mind the above problems occurring in the prior art, and an object of the present invention is to generate and store pieces of flow information and session information for respective Virtual LANs (VLANs) based on traffic occurring in various virtual machines present in a single cloud server.

Another object of the present invention is to provide a network monitoring method that searches pieces of stored flow information and session information for respective VLANs and transmits the results of the search to an information collector, thus strengthening cloud security.

A further object of the present invention is to generate sessions and flows in real time by inspecting all packets included in a network, thus minimizing the possibility of data loss.

In accordance with an aspect of the present invention to accomplish the above objects, there is provided an integrated network data collection apparatus, including a packet collection unit for collecting packets corresponding to one or more virtual machines included in a cloud server, a flow-processing unit for generating flow information based on the collected packets, a session-processing unit for generating session information based on the generated flow information, and a storage unit for storing network data including at least one of the generated flow information and the generated session information.

The packet collection unit may collect the packets at a level of a Network Interface Card (NIC).

The packet collection unit may collect packets corresponding to respective Virtual Local Area Networks (VLANs) of the virtual machines, and thus allow the flow-processing unit and the session-processing unit to generate the flow information and the session information, respectively, for each of the VLANs.

The integrated network data collection apparatus may further include a search unit for searching the stored network data for network data satisfying a predetermined condition, and transmitting results of the search to an information collector.

The search unit may receive the predetermined condition set by a user and search for the network data satisfying the set condition.

In accordance with another aspect of the present invention to accomplish the above objects, there is provided an integrated network data collection apparatus, including a packet collection unit for collecting packets corresponding to one or more virtual machines included in a cloud server, a flow-processing unit for generating flow information based on the collected packets, a session-processing unit for generating session information based on the generated flow information, and an interface unit for storing network data, including at least one of the generated flow information and the generated session information, in an external storage device and for receiving the network data from the storage device.

The interface unit may transmit a search condition to the storage device and receive network data satisfying the search condition from the storage device.

The packet collection unit may collect the packets at a level of a Network Interface Card (NIC).

The packet collection unit may collect packets corresponding to respective Virtual Local Area Networks (VLANs) of the virtual machines, and thus allow the flow-processing unit and the session-processing unit to generate the flow information and the session information, respectively, for each of the VLANs.

In accordance with a further aspect of the present invention to accomplish the above objects, there is provided an integrated network data collection method performed by an integrated network data collection apparatus, including collecting packets corresponding to one or more virtual machines included in a cloud server, generating flow information based on the collected packets, generating session information based on the generated flow information, and storing network data including at least one of the generated flow information and the generated session information.

Collecting the packets may be configured to collect the packets at a level of a Network Interface Card (NIC).

Collecting the packets may be configured to collect packets corresponding to respective VLANs of the virtual machines to generate pieces of network data for respective VLANs.

Storing the network data may be configured to store the network data in a storage unit provided in the integrated network data collection apparatus.

The integrated network data collection method may further include searching the pieces of network data stored in the storage unit for network data satisfying a predetermined condition, and transmitting results of the search to an information collector.

Storing the network data may be configured to transmit the network data to an external storage device and cause the network data to be stored in the external storage device.

The integrated network data collection method may further include transmitting a search condition to the storage device, receiving network data satisfying the search condition from the storage device, and transmitting the network data to an information collector.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating an integrated network data collection system according to an embodiment of the present invention;

FIG. 2 is a block diagram illustrating the configuration of a first integrated network data collection apparatus according to an embodiment of the present invention;

FIG. 3 is a block diagram illustrating the configuration of a second integrated network data collection apparatus according to an embodiment of the present invention;

FIG. 4 is a flowchart for explaining an integrated network data collection method according to an embodiment of the present invention;

FIG. 5 is a diagram for explaining the operation of a first integrated network data collection apparatus according to an embodiment of the present invention;

FIG. 6 is a diagram for explaining the operation of a second integrated network data collection apparatus according to an embodiment of the present invention; and

FIG. 7 is a block diagram illustrating a computer system according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

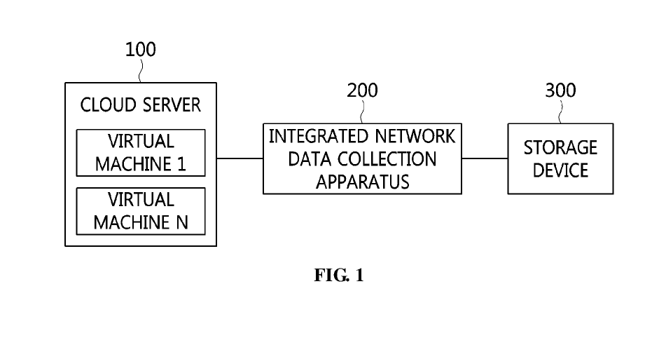

FIG. 1 is a diagram schematically illustrating an integrated network data collection system according to an embodiment of the present invention.

As illustrated in FIG. 1, the integrated network data collection system may include a cloud server 100, an integrated network data collection apparatus 200, and a storage device 300.

First, a single cloud server 100 includes a plurality of virtual machines. Further, the virtual machines included in the cloud server 100 provide respective operating systems and services.

The integrated network data collection apparatus 200 collects network packets at the level of a Network Interface Card (NIC), and generates flow information based on the collected network packets.

Further, the integrated network data collection apparatus 200 generates session information using the generated flow information, and stores network data including both the generated flow information and the generated session information. Here, the integrated network data collection apparatus 200 may store the network data, either in a storage unit provided in the integrated network data collection apparatus 200 or in an external storage device.

According to conventional technology, a flow generator, such as a router or a switch, and a search engine that generates sessions based on collected flows and searches the sessions and the flows are operated as separate structures. That is, the conventional session and flow search engine receives sampled flow information from the router, processes the sampled flow information, generates sessions, searches sessions and flows in response to a request from a user, and transmits the found sessions and flows to an information collector.

In contrast, the integrated network data collection apparatus 200 according to the embodiment of the present invention is implemented in a form in which a flow generator (e.g. a router, a switch, etc.) for generating flow information and a session and flow search engine for generating session information based on the flow information and searching the flow information and the session information are integrated with each other, thus supporting the analysis of network security of the information collector.

That is, the integrated network data collection apparatus 200 according to the embodiment of the present invention may be implemented so as to be integrated into a device for inspecting all network packets (total inspection) that are transmitted and received over a network and for generating flows and sessions in real time, and may perform a search operation in response to a request from a user and transmit the results of the search to the information collector, thus supporting secure analysis.

Finally, the storage device 300 stores the network data generated by the integrated network data collection apparatus 200.

When the integrated network data collection apparatus 200 is not provided with a storage unit, the storage device 300 may receive network data from the integrated network data collection apparatus 200 and may store the received network data.

The storage device 300 receives network data from the integrated network data collection apparatus 200 through the interface unit of the integrated network data collection apparatus 200. Further, the storage device 300 stores the received network data. Here, the storage device 300 may mean big data storage, and the type of the storage device 300 is not limited thereto.

Further, the storage device 300 may search for network data corresponding to a data search request received from the integrated network data collection apparatus 200, and may transmit the results of the search to the integrated network data collection apparatus 200.

Although the integrated network data collection system has been described as including the storage device 300 for the convenience of description, the structure of the present invention is not limited thereto. When the integrated network data collection apparatus 200 includes therein a storage unit, the integrated network data collection system may not include the storage device 300.

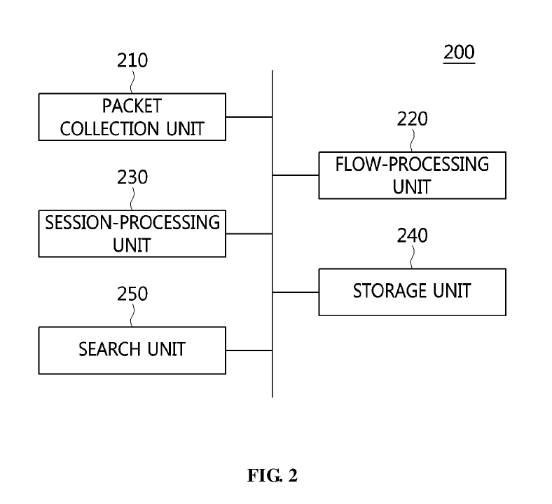

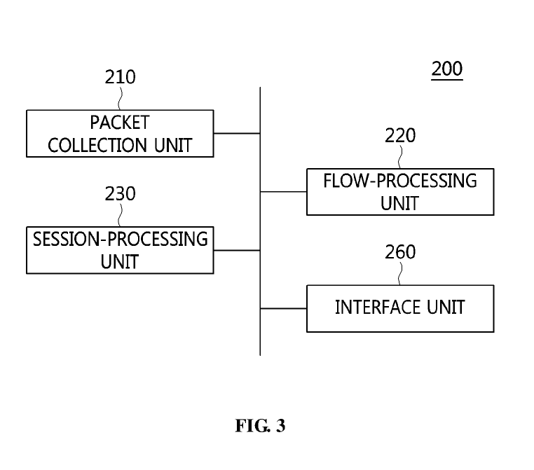

Hereinafter, the configuration of an integrated network data collection apparatus according to an embodiment of the present invention will be described in detail with reference to FIGS. 2 and 3.

For the convenience of description, the integrated network data collection apparatus, which includes a storage unit and a search unit, is referred to as a “first integrated network data collection apparatus 200,” and an integrated network data collection apparatus, which stores and searches network data while performing communication with an external storage device, is referred to as a “second integrated network data collection apparatus 300”.

FIG. 2 is a block diagram illustrating the configuration of the first integrated network data collection apparatus according to an embodiment of the present invention.

As illustrated in FIG. 2, the first integrated network data collection apparatus 200 includes a packet collection unit 210, a flow-processing unit 220, a session-processing unit 230, a storage unit 240, and a search unit 250.

First, the packet collection unit 210 collects network packets corresponding to one or more virtual machines included in a cloud server 100. Here, the packet collection unit 210 may collect packets at the level of a Network Interface Card (NIC), and may store the collected packets.

Further, the packet collection unit 210 may collect packets corresponding to respective Virtual LANs (VLANs) of the virtual machines and may allow the flow-processing unit 220 and the session-processing unit 230 to generate flow information and session information, respectively, for each VLAN, based on the collected packets.

Next, the flow-processing unit 220 generates flow information based on the collected packets. Here, the flow-processing unit 220 may generate pieces of flow information for respective VLANs, and may manage the generation and termination of flows.

The session-processing unit 230 may generate session information based on the generated flow information, and may manage the generation and termination of sessions. Here, the session-processing unit 230 may generate pieces of session information for respective VLANs.

The storage unit 240 stores network data that includes at least one of the generated flow information and the generated session information. Here, the storage unit 240 may store pieces of network data for respective virtual machines.

Finally, the search unit 250 searches the pieces of network data stored in the storage unit 240 for network data satisfying a predetermined condition. Further, the search unit 250 may transmit the results of the search to an information collector. Here, the search unit 250 may search pieces of network data stored for respective virtual machines and may transmit the results of the search to the information collector.

Also, the search unit 250 may receive a search condition required to search for network data, which is set by a user, from the user, and may search for network data satisfying the set search condition.

In this way, the integrated network data collection apparatus 200 may monitor pieces of network data for respective virtual machines, thus improving cloud security.

FIG. 3 is a block diagram illustrating the configuration of the second integrated network data collection apparatus according to an embodiment of the present invention.

As illustrated in FIG. 3, a second integrated network data collection apparatus 200 includes a packet collection unit 210, a flow-processing unit 220, a session-processing unit 230, and an interface unit 260.

First, the packet collection unit 210 collects network packets corresponding to one or more virtual machines included in the cloud server 100, and stores the collected network packets. Here, the packet collection unit 210 may collect packets at the level of a network interface card (NIC). Here, the packet collection unit 210 is substantially identical to the packet collection unit 210 of the first integrated network data collection apparatus 200 illustrated in FIG. 2, and thus a repeated description thereof will be omitted.

Further, the flow-processing unit 220 generates flow information based on the collected packets. Here, the flow-processing unit 220 is substantially identical to the flow-processing unit 220 of the first integrated network data collection apparatus 200 illustrated in FIG. 2, and thus a repeated description thereof will be omitted.

Next, the session-processing unit 230 generates session information based on the flow information generated by the flow-processing unit 220. Here, the session-processing unit 230 is substantially identical to the session-processing unit 230 of the first integrated network data collection apparatus 200 illustrated in FIG. 2, and thus a repeated description thereof will be omitted.

Finally, the interface unit 260 transmits network data, including at least one of the generated flow information and the generated session information, to an external storage device 300 to cause the network data to be stored in the storage device 300. Further, the interface unit 260 may receive network data satisfying a search condition from the storage device 300 in which the network data is stored.

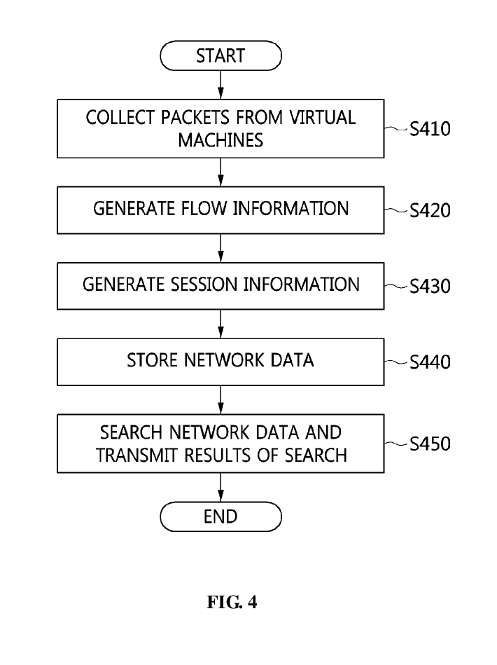

FIG. 4 is a flowchart for explaining an integrated network data collection method according to an embodiment of the present invention.

First, the integrated network data collection apparatus 200 collects packets from virtual machines at step S410.

The integrated network data collection apparatus 200 collects network packets corresponding to one or more virtual machines included in a cloud server. Here, the network packets may be collected at the level of a Network Interface Card (NIC), and packets corresponding to respective VLANs of the virtual machines may be collected.

Further, the integrated network data collection apparatus 200 generates flow information at step S420.

The integrated network data collection apparatus 200 generates flow information using the network packets collected at step S410. Here, the integrated network data collection apparatus 200 may generate pieces of flow information for respective VLANs and may manage the generation and termination of flows.

Next, the integrated network data collection apparatus 200 generates session information using the flow information at step S430.

The integrated network data collection apparatus 200 generates pieces of session information for respective VLANs using the generated flow information, and manages the generation and termination of sessions.

Also, the integrated network data collection apparatus 200 stores network data including at least one of the generated flow information and the generated session information at step S440.

The integrated network data collection apparatus 200 may store pieces of network data for respective virtual machines when storing the network data.

Finally, the integrated network data collection apparatus 200 may search the stored network data and transmit the results of the search to an information collector at step S450.

In detail, the integrated network data collection apparatus 200 may search the pieces of stored network data for network data satisfying a predetermined condition and transmit the found network data to the information collector, thus supporting secure analysis performed by the information collector.

According to conventional technology, session information may be generated using flow information (e.g. CFlow, Jflow, or Netflow) received from network equipment, such as a router or a switch, and then the session information and the flow information may be searched. That is, the conventional technology may entail the possibility of data loss during a procedure for receiving the flow information from the network equipment, and may process only flows having a specific sampled form.

However, the integrated network data collection apparatus 200 according to the embodiment of the present invention is implemented in a form in which a function of generating flow information and a function of generating session information and searching network data are integrated with each other, and thus the flow information is less likely to be lost.

Further, since the integrated network data collection apparatus 200 processes flow information on which total inspection has been completed, the integrated network data collection apparatus 200 may improve the accuracy of analysis of cloud security.

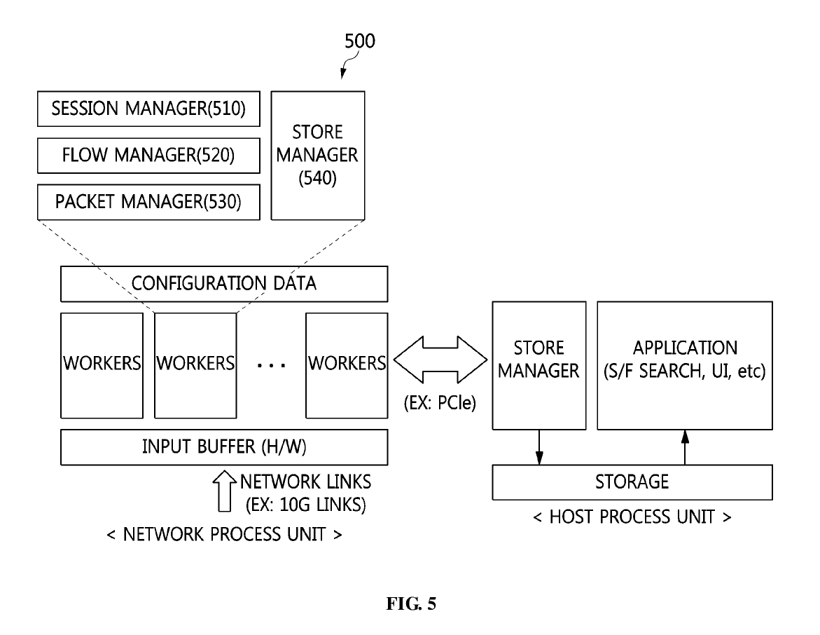

FIG. 5 is a diagram for explaining the operation of a first integrated network data collection apparatus according to an embodiment of the present invention.

As illustrated in FIG. 5, a first integrated network data collection apparatus 500 according to another embodiment of the present invention may include a packet manager 530, a flow manager 520, a session manager 510, and a store manger 540.

Since the packet manager 530, the flow manager 520, and the session manager 510 of FIG. 5 are substantially identical to the packet collection unit 210, the flow-processing unit 220, and the session-processing unit 230 of the first integrated network data collection apparatus 200 illustrated in FIG. 2, a repeated description thereof will be omitted. Further, since the store manager 540 is substantially identical to the storage unit 240 and the search unit 250 of the first integrated network data collection apparatus 200 illustrated in FIG. 2, a repeated description thereof will be omitted.

As illustrated in FIG. 5, the first integrated network data collection apparatus 500 may generate and store pieces of network data for respective virtual machines, and may search for network data satisfying a search condition and transmit the found network data to a host process unit through Peripheral Component Interconnect (PCI) Express.

Here, the host process unit may be an information collector that receives the results of searching for flow information and session information from the first integrated network data collection apparatus 500, and then performs security analysis.

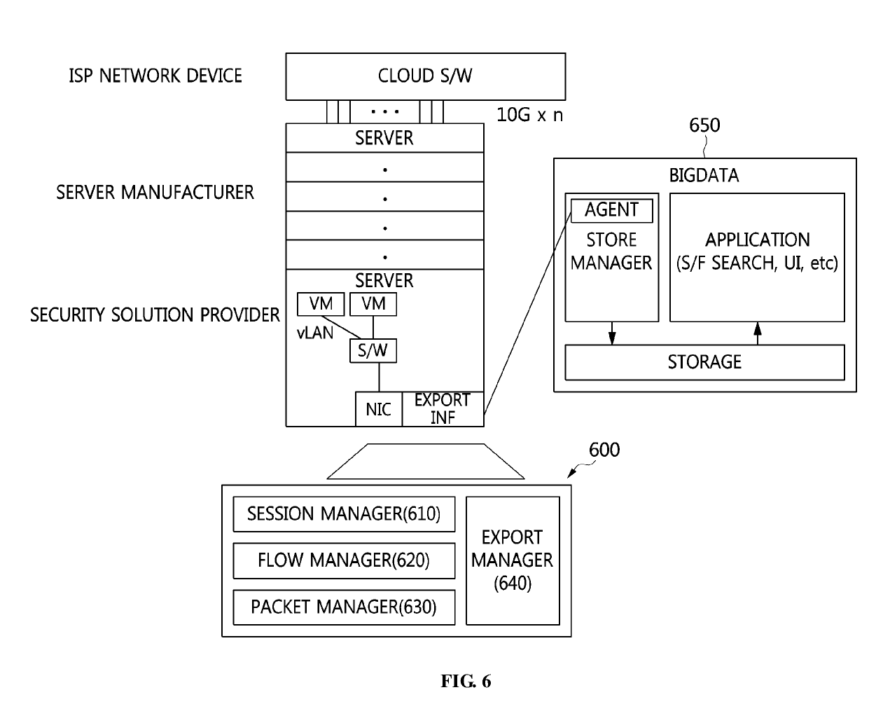

FIG. 6 is a diagram for explaining the operation of a second integrated network data collection apparatus according to an embodiment of the present invention.

As illustrated in FIG. 6, a second integrated network data collection apparatus 600 is implemented in a form in which a flow generator, which generates flow information occurring when respective virtual machines communicate with each other at the level of an NIC based on packet information, and a session and flow search engine, which generates session information based on the flow information and searches the flow information and the session information, are integrated with each other.

The second integrated network data collection apparatus 600 may include a packet manager 630, a flow manager 620, a session manager 610, and an export manager 640.

Since the packet manager 630, the flow manager 620, and the session manager 610 of FIG. 6 are substantially identical to the packet collection unit 210, the flow-processing unit 220, and the session-processing unit 230 of the second integrated network data collection apparatus 200 illustrated in FIG. 3, a repeated description thereof will be omitted. Further, since the export manager 640 is substantially identical to the interface unit 260 of the second integrated network data collection apparatus 200 illustrated in FIG. 3, a repeated description thereof will be omitted.

Furthermore, the second integrated network data collection apparatus 600 may store the flow information and the session information in an independent external system for storing network data while communicating with the independent external system.

Here, the external system may mean a big data system 650, and the second integrated network data collection apparatus 600 may transmit the network data to the big data system 650 through the export manager 640 to cause the network data to be stored in the big data system 650.

Furthermore, the big data system 650 may include a store manager and storage, which receive the network data from the second integrated network data collection apparatus 600 and store the network data. In addition, the big data system 650 may include an application for searching the network data in response to a request from the second integrated network data collection apparatus 600.

In this way, the integrated network data collection apparatus according to the embodiment of the present invention may process the network data either in a centralized processing manner, as illustrated in FIG. 5, or in a distributed processing manner, as illustrated in FIG. 6. When the distributed processing is performed, as illustrated in FIG. 6, the integrated network data collection apparatus according to the embodiment of the present invention may transmit and receive network data through Peer-to-Peer (P2P) communication, and may then analyze the network data.

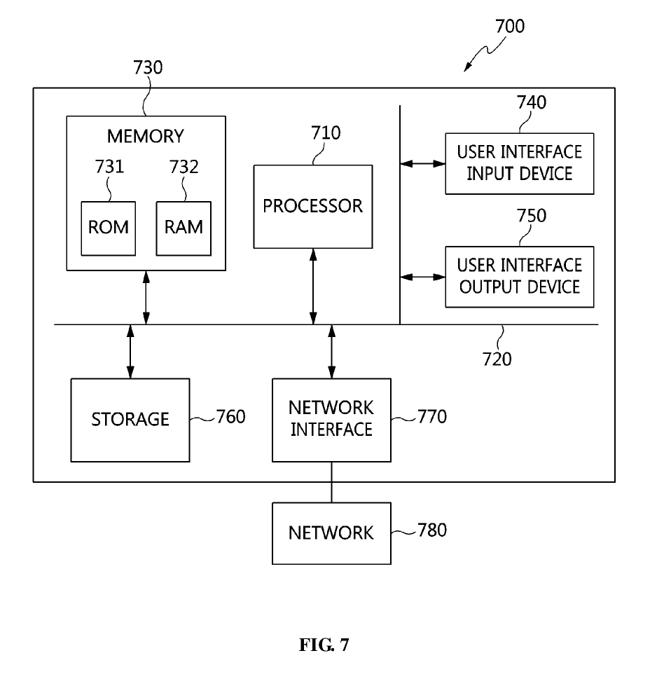

FIG. 7 is a block diagram illustrating a computer system according to an embodiment of the present invention.

Referring to FIG. 7, the embodiment of the present invention may be implemented in a computer system 700 such as a computer-readable storage medium. As illustrated in FIG. 7, the computer system 700 may include one or more processors 710, memory 730, a user interface input device 740, a user interface output device 750, and storage 760, which communicate with each other through a bus 720. The computer system 700 may further include a network interface 770 connected to a network 780. Each processor 710 may be a Central Processing Unit (CPU) or a semiconductor device for executing processing instructions stored in the memory 730 or the storage 760. Each of the memory 730 and the storage 760 may be any of various types of volatile or nonvolatile storage media. For example, the memory 730 may include Read-Only Memory (ROM) 731 or Random Access Memory (RAM) 732.

Therefore, the embodiment of the present invention may be implemented as a non-temporary computer-readable medium in which a computer-implemented method is recorded or in which computer-executable instructions are recorded. When the computer-executable instructions are executed by the processor, the instructions may perform the method according to at least one aspect of the present invention.

In accordance with the present invention, pieces of flow information and session information for respective Virtual LANs (VLANs) may be generated and stored based on traffic occurring in various virtual machines present in a single cloud server.

Further, in accordance with the present invention, there can be provided a network monitoring method that searches pieces of stored flow information and session information for respective VLANs and transmits the results of the search to an information collector, thus strengthening cloud security.

Furthermore, in accordance with the present invention, sessions and flows may be generated in real time by inspecting all packets included in a network, thus minimizing the possibility of data loss.

As described above, in the integrated network data collection apparatus and method according to the present invention, the configurations and schemes in the above-described embodiments are not limitedly applied, and some or all of the above embodiments can be selectively combined and configured such that various modifications are possible.

What is claimed is:

1. An integrated network data collection apparatus, comprising:
a packet collection unit for collecting packets corresponding to one or more virtual machines included in a cloud server;
a flow-processing unit for generating flow information based on the collected packets;
a session-processing unit for generating session information based on the generated flow information; and
a storage unit for storing network data including at least one of the generated flow information and the generated session information.

2. The integrated network data collection apparatus of claim 1, wherein the packet collection unit collects the packets at a level of a Network Interface Card (NIC).

3. The integrated network data collection apparatus of claim 2, wherein the packet collection unit collects packets corresponding to respective Virtual Local Area Networks (VLANs) of the virtual machines, and thus allows the flow-processing unit and the session-processing unit to generate the flow information and the session information, respectively, for each of the VLANs.

4. The integrated network data collection apparatus of claim 3, further comprising a search unit for searching the stored network data for network data satisfying a predetermined condition, and transmitting results of the search to an information collector.

5. The integrated network data collection apparatus of claim 4, wherein the search unit receives the predetermined condition set by a user and searches for the network data satisfying the set condition.

6. An integrated network data collection apparatus, comprising:
a packet collection unit for collecting packets corresponding to one or more virtual machines included in a cloud server;
a flow-processing unit for generating flow information based on the collected packets;
a session-processing unit for generating session information based on the generated flow information; and
an interface unit for storing network data, including at least one of the generated flow information and the generated session information, in an external storage device and for receiving the network data from the storage device.

7. The integrated network data collection apparatus of claim 6, wherein the interface unit transmits a search condition to the storage device and receives network data satisfying the search condition from the storage device.

8. The integrated network data collection apparatus of claim 7, wherein the packet collection unit collects the packets at a level of a Network Interface Card (NIC).

9. The integrated network data collection apparatus of claim 8, wherein the packet collection unit collects packets corresponding to respective Virtual Local Area Networks (VLANs) of the virtual machines, and thus allows the flow-processing unit and the session-processing unit to generate the flow information and the session information, respectively, for each of the VLANs.

10. An integrated network data collection method performed by an integrated network data collection apparatus, comprising:
collecting packets corresponding to one or more virtual machines included in a cloud server;
generating flow information based on the collected packets;
generating session information based on the generated flow information; and
storing network data including at least one of the generated flow information and the generated session information.

11. The integrated network data collection method of claim 10, wherein collecting the packets is configured to collect the packets at a level of a Network Interface Card (NIC).

12. The integrated network data collection method of claim 11, wherein collecting the packets is configured to collect packets corresponding to respective VLANs of the virtual machines to generate pieces of network data for respective VLANs.

13. The integrated network data collection method of claim 12, wherein storing the network data is configured to store the network data in a storage unit provided in the integrated network data collection apparatus.

14. The integrated network data collection method of claim 13, further comprising:
searching the pieces of network data stored in the storage unit for network data satisfying a predetermined condition; and
transmitting results of the search to an information collector.

15. The integrated network data collection method of claim 12, wherein storing the network data is configured to transmit the network data to an external storage device and cause the network data to be stored in the external storage device.

16. The integrated network data collection method of claim 15, further comprising:
transmitting a search condition to the storage device;
receiving network data satisfying the search condition from the storage device; and
transmitting the network data to an information collector.
